(19) United States
(12) Patent Application Publication
(10) Pub. No.: US 2015/0045041 A1
(43) Pub. Date: Feb. 12, 2015

(54) DEVICES AND METHODS FOR ESTABLISHING TRANSCODER-FREE COMMUNICATION PATHS WITH MULTI-SIM DEVICES

(71) Applicant: QUALCOMM Incorporated, San Diego, CA (US)

(72) Inventors: Chandra Mouli POLISETTY, San Diego, CA (US); Deepti MANI, San Diego, CA (US)

(73) Assignee: QUALCOMM Incorporated, San Diego, CA (US)

(21) Appl. No.: 13/964,395

(22) Filed: Aug. 12, 2013

(51) Int. Cl. H04W 40/28; H04W 88/06

(52) U.S. Cl. CPC H04W 40/28; H04W 88/06
USPC 455/445

(57) ABSTRACT

Multi-subscription access terminals are adapted to facilitate establishment of a transcoder-free communication path. According to at least one example, an access terminal can initiate a call with a terminating communication device using a first subscription, including attempting to establish a transcoder-free communication path. If a transcoder-free communication path cannot be established using the first subscription, the access terminal can switch to using a second subscription. The access terminal can then initiate a call with the terminating communication device using the second subscription module, including attempting again to establish a transcoder-free communication path.

### TECHNICAL FIELD

The following relates generally to wireless communications, and more specifically to methods and devices for facilitating establishing a transcoder-free communication path with devices incorporating multiple subscription modules.

### BACKGROUND

Wireless communications systems are widely deployed to provide various types of communication content such as voice, video, packet data, messaging, broadcast, and so on. These systems may be accessed by various types of access terminals adapted to facilitate wireless communications, where multiple access terminals share the available system resources (e.g., time, frequency, and power). Examples of such wireless communications systems include code-division multiple access (CDMA) systems, time-division multiple access (TDMA) systems, frequency-division multiple access (FDMA) systems and orthogonal frequency-division multiple access (OFDMA) systems.

In some instances, access terminals can be adapted to support a plurality of subscriptions (e.g., via a plurality of subscriber identity modules (SIMs)). An access terminal with multiple subscription capabilities (e.g., multiple SIMs) may be able to use multiple services without the need to carry multiple access terminals at the same time. Each subscription (e.g., SIM) may be associated with a different subscriber account, a different network, and/or a different radio access technology (RAT). In such examples, the same access terminal can be used for business and private use with separate numbers and separate bills, or for travel when an additional SIM is employed for a visited country. Some multiple subscription configurations enable each subscription to be active simultaneously, allowing calls to be received on either number at any given time (e.g., Dual SIM Dual Standby (DSDS), Dual SIM Dual Active (DSDA), Triple SIM Triple Standby (TSTS)).

### BRIEF SUMMARY OF SOME EXAMPLES

Since some access terminals can support multiple subscriptions, it may be desirable to employ the multiple subscription capabilities to facilitate establishment of transcoder-free communication paths between communication devices. Various examples and implementations of the present disclosure facilitate establishment of transcoder-free communication paths with devices employing multiple subscriptions.

According to at least one aspect of the present disclosure, access terminals may include a communications interface and a plurality of subscription modules, each coupled with a processing circuit. The plurality of subscription modules may include a first subscription module associated with a first subscription, and a second subscription module associated with a second subscription. The processing circuit may be adapted to initiate a call with a terminating communication device via the communications interface using the first subscription module. If a transcoder-free communication path cannot be established using the first subscription module, the processing circuit may be further adapted to switch to the second subscription module, and initiate the call with the terminating communication device via the communications interface using the second subscription module. Initiating a call may include attempting to establish a transcoder-free communication path with the terminating communication device.

Further aspects of the present disclosure provide methods operational on an access terminal and/or access terminals including means to perform such methods. One or more examples of such methods may include initiating a call with a terminating communication device using a first subscription. Such methods may further include switching to a second subscription if a transcoder-free communication path cannot be established with the terminating communication device using the first subscription module. The call may then be initiated with the terminating communication device using the second subscription. Initiation of a call may include attempting to establish a transcoder-free communication path with the terminating communication device.

Still further aspects include computer-readable storage mediums comprising programming operational on a computer, such as a wireless communications device. According to one or more examples, such programming may be adapted for causing a computer to initiate a call with a terminating communication device using a first subscription, such as by attempting to establish a transcoder-free communication path with the terminating communication device. The programming may also be adapted to cause a computer to switch to a second subscription if a transcoder-free communication path cannot be established with the terminating communication device using the first subscription module. On switching to the second subscription, the programming may be adapted to cause a computer to initiate the call with the terminating communication device using the second subscription, such as by attempting to establish a transcoder-free communication path with the terminating communication device.

Other aspects, features, and embodiments associated with the present disclosure will become apparent to those of ordinary skill in the art upon reviewing the following description in conjunction with the accompanying figures.

### DRAWINGS

FIG. 1 is a block diagram of a network environment in which one or more aspects of the present disclosure may find application.

FIG. 2 is a block diagram illustrating select components of the wireless communication system of FIG. 1 according to at least one example.

FIG. 3 is a block diagram illustrating a communication session between an originating access terminal (AT) and a terminating AT via an originating gateway, a transit (intermediate) gateway, and a terminating gateway.

FIG. 4 is a flow diagram illustrating one example of establishing a typical transcoder free operation (TrFO) or tandem free operation (TFO) connection/call.

FIG. 5 is made up of FIGS. 5A and 5B, and shows a flow diagram illustrating at least one example of establishing a transcoder-free communication path for an access terminal employing multiple subscriptions.

FIG. 6 is a block diagram illustrating select components of an access terminal according to at least one example.

FIG. 7 is a flow diagram illustrating a method operational on multi-subscription access terminal for establishing a transcoder-free communication path.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of telecommunication systems, network architectures, and communication standards. Certain aspects of the disclosure may be described below using terminology related to one or more specific protocols, systems, and/or technologies. However, those of ordinary skill in the art will recognize that one or more aspects of the present disclosure may be employed and included in one or more other wireless communication protocols, systems, and technologies.

### Overview

Various features facilitate establishment of a transcoder-free communication path from an originating access terminal employing multiple subscriptions (e.g., multi-SIM access terminal) to a terminating access terminal over one or more communication networks. The originating access terminal initially attempts to establish a transcoder-free path to the terminating access terminal using a first subscription (e.g., via a first network associated with a first SIM). If a transcoder-free path cannot be established using the first subscription, then the originating access terminal can automatically switch to a second subscription, and attempt to establish a transcoder-free path to the same terminating access terminal (e.g., via a second network associated with a second SIM). This same process may be repeated with other available subscriptions (e.g., a third subscription, fourth subscription, etc.) until a transcoder-free path is established.

In some exemplary implementations, attempts to establish a transcoder-free path over distinct subscriptions may be limited to two, three, or four subscriptions so as to not cause undue or noticeable delays to an operator/user. If a transcoder-free path cannot be established after a threshold number of attempts using different subscriptions, then the originating access terminal may simply: (a) establish a best available communication path (e.g., path with least number of transcoders, or only available path) with the terminating access terminal using the current or last used subscription, and/or (b) switch back to a preferred, default, or initial subscription and establish a best available communication path (e.g., path with least number of transcoders, or only available path) with the terminating access terminal.

### Exemplary Operating Environment

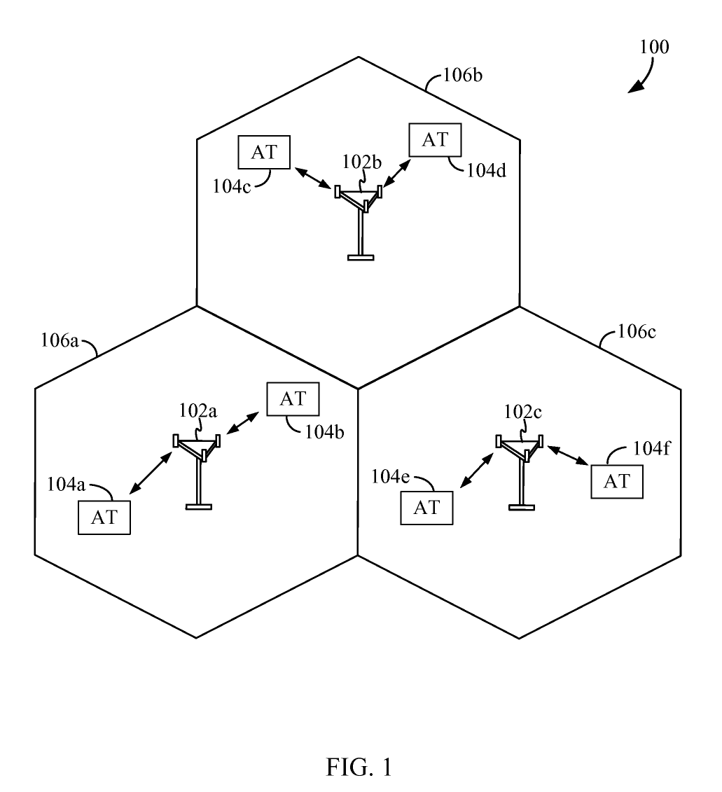

FIG. 1 is a block diagram illustrating a network environment in which one or more aspects of the present disclosure may find application. The wireless communications system 100 is adapted to facilitate wireless communication between one or more base stations 102a, 102b, and 102c (collectively referred to as “base stations 102”) and access terminals 104a, 104b, 104c, 104d, 104e, and 104f (collectively referred to as “access terminals 104”). The base stations 102 and access terminals 104 may be adapted to interact with one another through wireless signals. In some instances, such wireless interaction may occur on multiple carriers (waveform signals of different frequencies). Each modulated signal may carry control information (e.g., pilot signals), overhead information, data, etc.

The base stations 102 can wirelessly communicate with the access terminals 104 via a base station antenna. The base stations 102 may each be implemented generally as a device adapted to facilitate wireless connectivity (for one or more access terminals 104) to the wireless communications system 100. Such a base station 102 may also be referred to by those skilled in the art as a base transceiver station (BTS), a radio base station, a radio transceiver, a transceiver function, a basic service set (BSS), and extended service set (ESS), a node B, a femto cell, a pico cell, or some other suitable terminology.

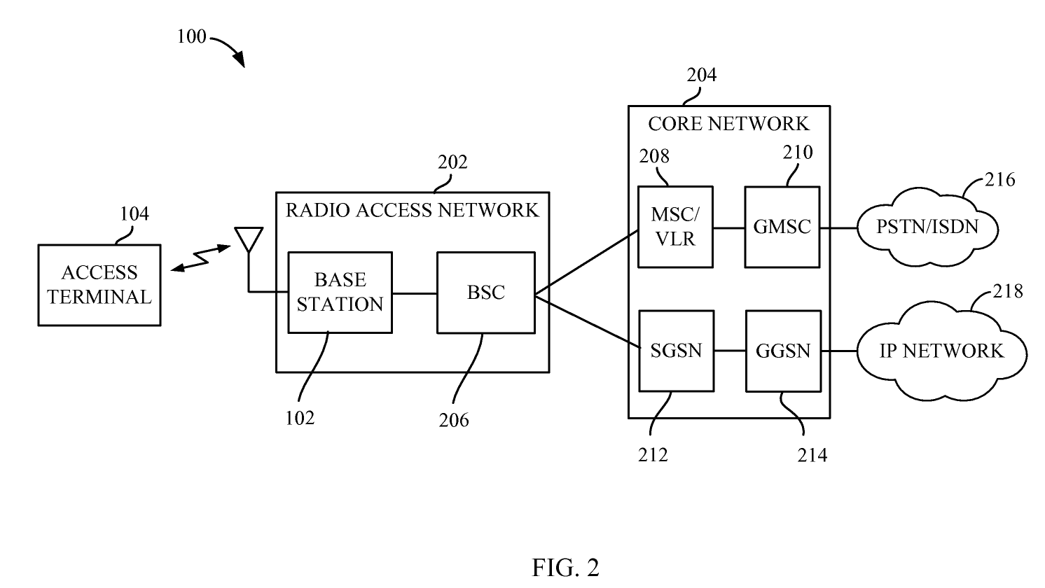

The base stations 102 are configured to communicate with the access terminals 104 under the control of a base station controller (see FIG. 2). Each of the base station 102 sites can provide communication coverage for a respective geographic area. The coverage area 106 for each base station 102 here is identified as cells 106a, 106b, or 106c. The coverage area 106 for a base station 102 may be divided into sectors (not shown, but making up only a portion of the coverage area). In various examples, the system 100 may include base stations 102 of different types.

One or more access terminals 104 may be dispersed throughout the coverage areas 106. Each access terminal 104 may communicate with one or more base stations 102. An access terminal 104 may generally include one or more devices that communicate with one or more other devices through wireless signals. Such an access terminal 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. An access terminal 104 may include a mobile terminal and/or an at least substantially fixed terminal Examples of an access terminal 104 include a mobile phone, a pager, a wireless modem, a personal digital assistant, a personal information manager (PIM), a personal media player, a palmtop computer, a laptop computer, a tablet computer, a television, an appliance, an e-reader, a digital video recorder (DVR), a machine-to-machine (M2M) device, and/or other communication/computing device which communicates, at least partially, through a wireless or cellular network.

In some instances, one or more of the access terminals 104 may be adapted to support a plurality of subscriptions (e.g., via a plurality of subscriber identity modules (SIMs)), such as Dual SIM Dual Standby (DSDS), Dual SIM Dual Active (DSDA), Triple SIM Triple Standby (TSTS), etc. Each subscription may be associated with a different subscriber account, a different network, and/or a different radio access technology (RAT).

FIG. 2 is a block diagram illustrating select components of the wireless communication system 100 is depicted according to at least one example. As illustrated, the base stations 102 are included as at least a part of a radio access network (RAN) 202. The radio access network (RAN) 202 is generally adapted to manage traffic and signaling between one or more access terminals 104 and one or more other network entities, such as network entities included in a core network 204. The radio access network 202 may, according to various implementations, be referred to by those skill in the art as a base station subsystem (BSS), an access network, a GSM Edge Radio Access Network (GERAN), a UMTS Terrestrial Radio Access Network (UTRAN), etc.

In addition to one or more base stations 102, the radio access network 202 can include a base station controller (BSC) 206, which may also be referred to by those of skill in the art as a radio network controller (RNC). The base station controller 206 is generally responsible for the establishment, release, and maintenance of wireless connections within one or more coverage areas associated with the one or more base stations 102 which are connected to the base station controller 206. The base station controller 206 can be communicatively coupled to one or more nodes or entities of the core network 204.

The core network 204 is a portion of the wireless communications system 100 that provides various services to access terminals 104 that are connected via the radio access network 202. The core network 204 may include a circuit-switched (CS) domain and a packet-switched (PS) domain. Some examples of circuit-switched entities include a mobile switching center (MSC) and visitor location register (VLR), identified as MSC/VLR 208, as well as a Gateway MSC (GMSC) 210. Some examples of packet-switched elements include a Serving GPRS Support Node (SGSN) 212 and a Gateway GPRS Support Node (GGSN) 214. Other network entities may be included, such as an equipment identity register (EIR), a home location register (HLR), a visitor location register (VLR), and/or an authentication center (AuC), some or all of which may be shared by both the circuit-switched and packet-switched domains. An access terminal 104 can obtain access to a public switched telephone network (PSTN) 216 via the circuit-switched domain, and to an interne protocol (IP) network 218 via the packet-switched domain.

As an access terminal 104 operates within the wireless communication system 100, the access terminal 104 may participate in voice communications with one or more other access terminals that may be within the same or a different wireless communication system.

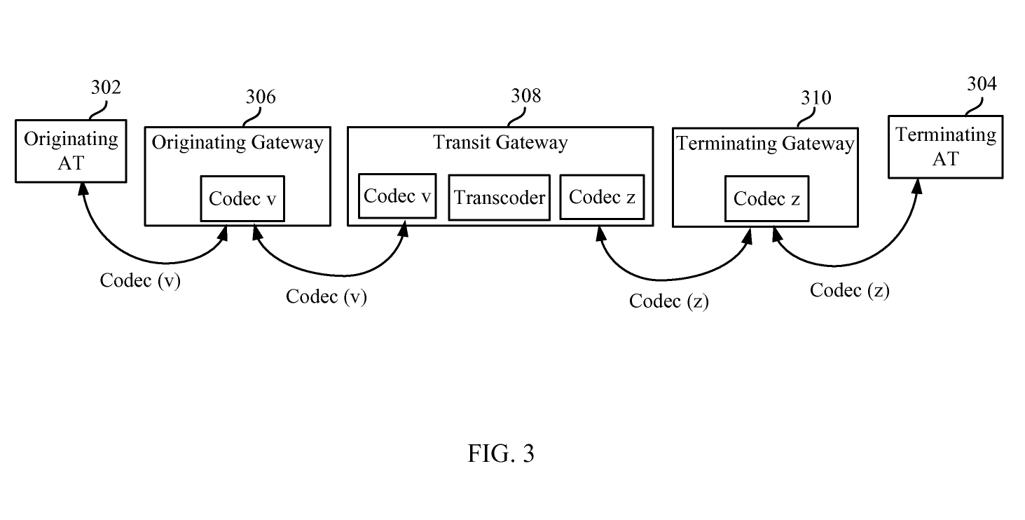

FIG. 3 is a block diagram illustrating a communication session between an originating access terminal (AT) 302 and a terminating AT 304 via an originating gateway 306, a transit (intermediate) gateway 308, and a terminating gateway 310. In this example, a first codec format may be used between the originating gateway 306 and transit gateway 308 and a second codec format may be used between the transit gateway 308 and terminating gateway 310. Consequently, a transcoder is used by the transit gateway 308 to convert between the first codec format and the second codec format.

Such conversion typically results in a loss of signal quality (e.g., loss of audio fidelity, loss of video resolution, etc.). For example, many network operators use narrow band voice codecs. If transcoders exist along the path of an audio call, quality of the reproduced audio at the other end deteriorates because of the coding loss incurred due to repetitive encoding/decoding (at each transcoder and codec).

It can be beneficial to facilitate communication sessions between multiple access terminals that is free of a transcoder. Such operation may be referred to by those of ordinary skill in the art as transcoder free operation (TrFO), tandem free operation (TFO) and/or other suitable terminology. In various examples, transcoder free operation (TrFO) may be implemented in 3G networks and Tandem Free Operation (TFO) may be implemented in 2G networks.

In some instances, out of band transcoder control functionality (OoBTC) may be employed to avoid transcoders along the data path. OoBTC is a signaling procedure initiated at call setup to avoid the use of transcoders during the call by negotiating a preferred codec to be used between the two end nodes (i.e., originating AT 302 and terminating AT 304). Typically, when no compatible codec type can be selected, the default pulse code modulation (PCM) coding is selected and the originating mobile switching center (MSC) introduces a transcoder in the path from the originating AT 302. Codec selection for the terminating AT 304 is then performed within the terminating MSC, independently of the originating MSC.

### Examples of Connection/Call Establishment

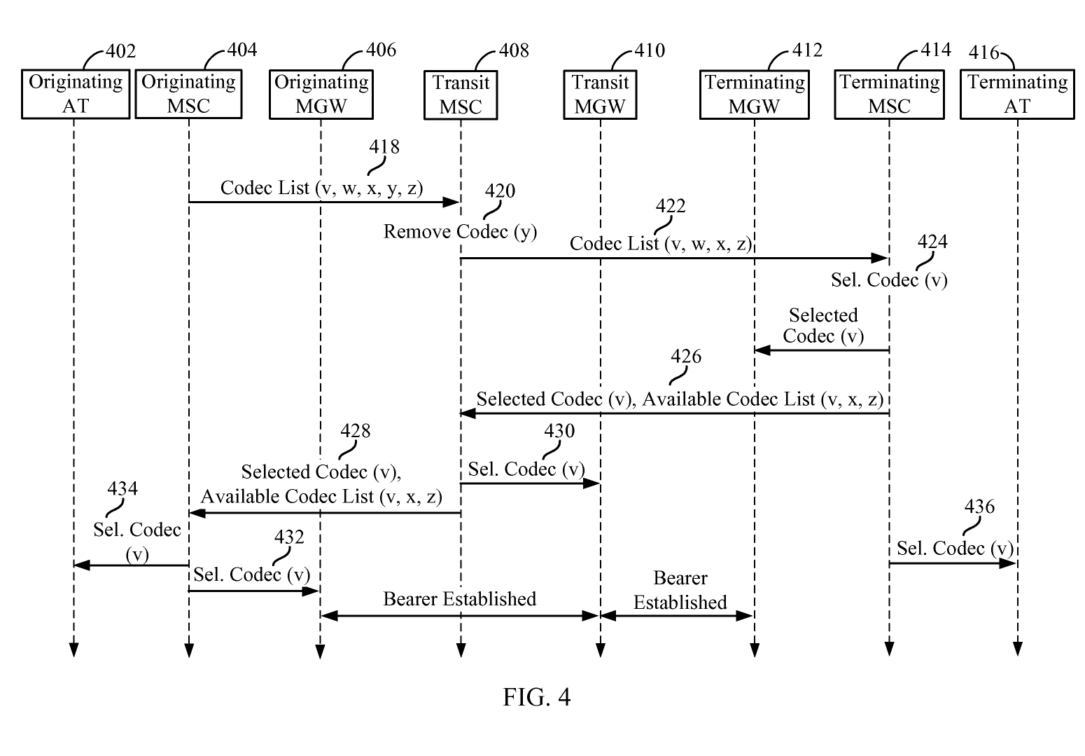

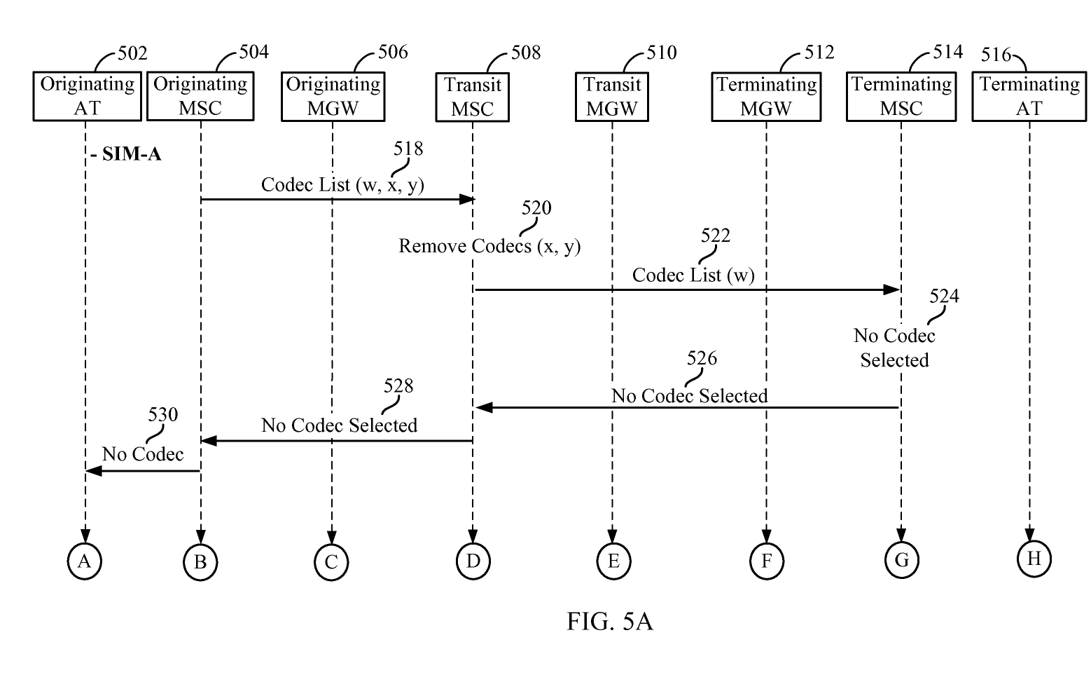

FIG. 4 is a block diagram illustrating one example of how a typical TrFO/TFO connection/call may be established for an access terminal. When a call is being setup between an originating AT 402 and a terminating AT 416, codec negotiation may start with an initial address message (IAM message) 418 containing a list of supported codec types, for example v, w, x, y, z, sent by the Originating MSC 404. Intermediary Transit nodes (e.g., Transit MSC 408) may delete codec types from the list which are not supported by the Transit nodes. In this example, transit node 408 has removed codec type y 420 from the Codec List 422 sent to the terminating MSC 414. The terminating MSC 414 selects the codec type, in this example Code v is selected 424. The selected codec may be conveyed in an Application Transport Message (APM message) 426, 428, together with the remaining list of alternative codecs, such as currently not selected codec types v, x, z, to the Transit Node 408 and/or the originating MSC 404. The Transit Node 408 and originating MSC 404 may then send respective codec selection messages 430, 432 to their corresponding gateways (MGW) 406 and 410 informing them of the selected codec (e.g., codec v in this example). The selected codec may also be sent 434, 436 to the originating AT 402 and to the terminating AT 416. As shown in this example, the terminating MSC 414 ultimately selects the codec to be used.

As noted above, when a common codec format cannot be found, a transcoder is used by the transit gateway to convert between the first codec format and the second codec format.

At least one aspect of the present disclosure access terminals and network nodes are adapted to facilitate employing multiple subscriptions (e.g., DSDS, DSDA, TSTS, etc.) to establish communication paths that are transcoder free (e.g., TrFO, TFO). Such features improve the chances that a common codec format can be found so that a use of a transcoder can be avoided. This not only improves audio quality but can also enable the access terminal to take advantage of watermarking techniques to deliver wideband voice quality over standardized narrowband codecs.

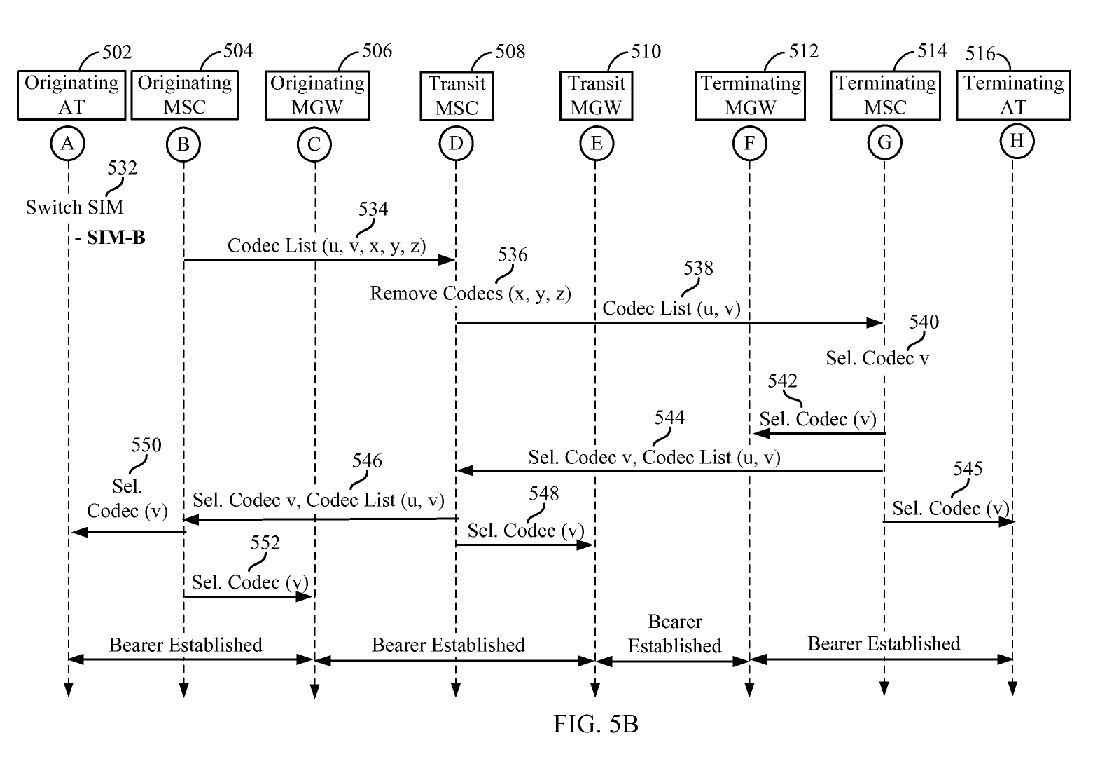

FIG. 5 (comprising FIGS. 5A and 5B) is a flow diagram illustrating at least one example of establishing a transcoder-free communication path for an access terminal 502 employing multiple subscriptions. In this example, the access terminal 502 is depicted as the originating access terminal. Referring initially to FIG. 5A, the originating access terminal 502, using a first subscription, may initiate a call with a terminating access terminal 516 by attempting to establish a transcoder-free connection with the terminating access terminal 516. As part of this procedure, a codec negotiation process takes place. For example, the originating MSC 504 may convey to the intermediary transit nodes (transit MSC 508) an initial address message (IAM message) 518 containing a list of supported codec types (e.g., w, x, y).

The transit nodes may remove 520 any non-supported codec, like x and y in this example, and the remaining codec list (e.g., w) 522 is conveyed to the terminating MSC 514. The terminating MSC 514 may further remove 524 any codecs that are not supported at its end. In the depicted example, the terminating MSC 514 removes the remaining codec as non-supported. If no codecs are supported, a no codec selected message 526 is conveyed to the transit MSC 508. A no codec selected message 528 can also be conveyed to the originating MSC 504. This lack of transcoder free path may be communicated 530 to the originating access terminal 502.

Turning to FIG. 5B, the process continues as depicted. In response to an indication that there is no transcoder free path available, the originating access terminal 502 may switch to a second subscription module. With the originating access terminal 502 switched to the second subscription module, the originating access terminal 502 initiates a new codec negotiation process for the second subscription module. For example, the originating MSC 504 convey to the intermediary transit nodes (transit MSC 508) an new initial address message (IAM message) 534 containing a list of supported codec types (e.g., u, v, x, y, z). The transit MSC 508 may remove 536 any non-supported codecs (e.g., x, y, and z) and forward the remaining codec list (e.g., u, v) 538 to the terminating MSC 514.

The terminating MSC 514 can select a supported codec (e.g., codec v) 540, and notifies the terminating MGW 512 and the transit MSC 508 of the selected codec. For instance, the terminating MSC 514 can convey an Application Transport Message (APM message) 542 identifying the selected codec to the terminating MGW 512. The terminating MSC 514 may also convey another APM message 544 identifying the selected codec (e.g., v) together with a list of alternative unselected codecs (e.g., u, v) to the transit MSC 508. Additionally, the terminating MSC 514 can convey a message 545 to the terminating access terminal 516 indicating the selected codec (e.g., v).

The information identifying the selected codec (e.g., v) together with a list of alternative unselected codecs (e.g., u, v) can also be conveyed from the transit MSC 508 to the originating MSC 504 in message 546. The transit MSC 508 can also inform the transit MGW 510 of the selected codec 548.

The originating MSC 504 can then notify the originating access terminal 502 with a message 550 identifying the selected codec (e.g., v). The originating MSC 504 also notifies the originating access terminal 502 with a message 552 identifying the selected codec (e.g., v).

Radio bearers can subsequently be established to form a communication path between the originating access terminal 502 and the terminating access terminal 516. In this manner, use of a single codec may be established along the communication path between the originating access terminal 502 and the terminating access terminal 516, resulting in a transcoder-free communication path.

### Exemplary Access Terminal

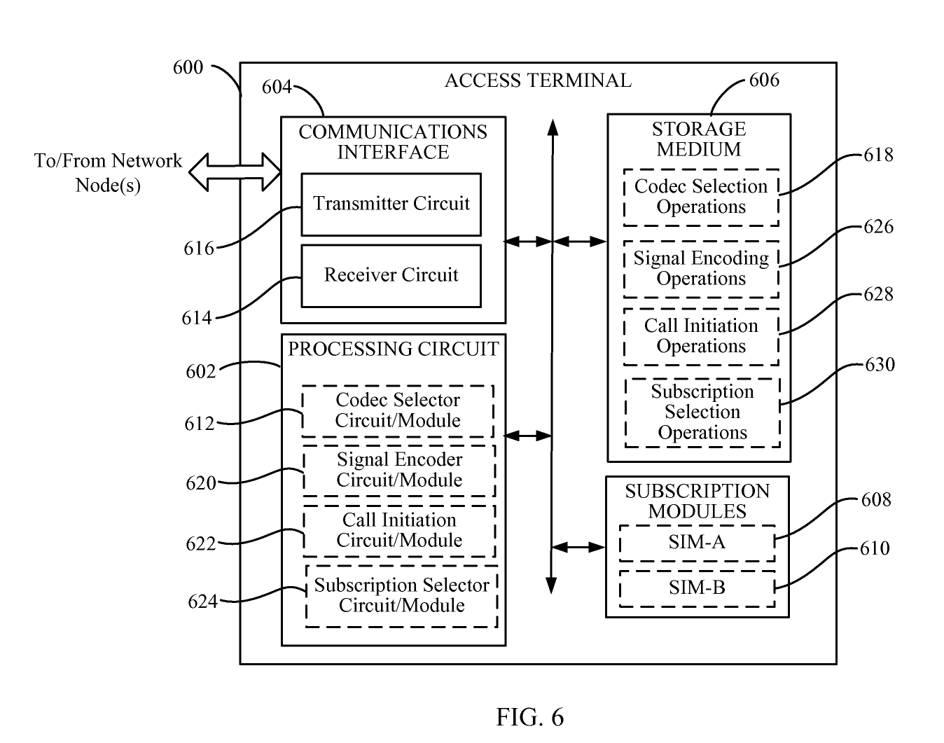

FIG. 6 is a block diagram illustrating select components of an access terminal 600 according to at least one example of the present disclosure. The access terminal 600 includes a processing circuit 602 coupled to or placed in electrical communication with a communications interface 604 and a storage medium 606.

According to an aspect of the present disclosure, the access terminal 600 is adapted to employ multiple subscriptions. Accordingly, the access terminal 600 further includes two or more subscription modules represented generally by SIM-A 608 and SIM-B 610. The subscription modules 608, 610 may also be referred to interchangeably herein as a subscriber identity module (SIM). However, the one or more subscription modules may be one or more suitable subscription modules including, but not limited to, a Subscriber Identity Module (SIM), Removable User Identity Module (R-UIM), Universal Integrated Circuit Card (UICC), CDMA Subscriber Identity Module (CSIM), Universal Subscriber Identity Module (USIM)), etc. SIM-A 608 and SIM-B 610 may be associated with a different service subscription, different network access over the same or different network type, and/or use the same or different radio access technologies. According to an aspect of the present disclosure, each subscription module 608, 610 may be capable of employing a plurality of codec formats. Furthermore, the list of available codec formats may be different for each subscription module 608, 610.

The processing circuit 602 is arranged to obtain, process and/or send data, control data access and storage, issue commands, and control other desired operations. The processing circuit 602 may include circuitry adapted to implement desired programming provided by appropriate media in at least one example. For example, the processing circuit 602 may be implemented as one or more processors, one or more controllers, and/or other structure configured to execute executable programming Examples of the processing circuit 602 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 602 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 602 are for illustration and other suitable configurations within the scope of the present disclosure are also contemplated.

The processing circuit 602 is adapted for processing, including the execution of programming, which may be stored on the storage medium 606. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 602 may include a codec selector 612, a subscription selector circuit/module 624, a call initiation circuit/module 622, and/or a signal encoder circuit/module 620. The codec selector circuit/module 612 may include circuitry and/or programming (e.g., programming stored on the storage medium 606, such as the codec selection operations 618) adapted to determine which subscription's paging channel to receive among a plurality of subscriptions. The subscription selector 624 may include circuitry and/or programming (e.g., programming stored on the storage medium 606, such as the subscription selection operations 630) adapted to select between two or more subscriptions (e.g., SIMs) available to the access terminal to use in establishing or initiating a call. The call initiation circuit/module 622 may include circuitry and/or programming (e.g., programming stored on the storage medium 606, such as the call initiation operations 628) adapted to attempt to setup or initiate a transcoder-free call with a terminating device. The signal encoder circuit/module 620 may include circuitry and/or programming (e.g., programming stored on the storage medium 606, such as the signal encoding operations 626) adapted to encode a wideband audio signal using a narrowband codec for transmission via the communications interface 604 using the transcoder-free communication path.

The communications interface 604 is configured to facilitate wireless communications of the access terminal 600. For example, the communications interface 604 may include circuitry and/or programming adapted to facilitate the communication of information bi-directionally with respect to one or more wireless network devices (e.g., network nodes). The communications interface 604 may be coupled to one or more antennas (not shown), and includes wireless transceiver circuitry, including at least one receiver circuit 614 (e.g., one or more receiver chains) and at least one transmitter circuit 616 (e.g., one or more transmitter chains). The communications interface 604 can be adapted to employ a plurality of different codec formats. In some instances, different codec formats may be employed at the communications interface 604 with different subscription modules 608, 610.

The storage medium 606 may represent one or more computer-readable, machine-readable, and/or processor-readable devices for storing programming, such as processor executable code or instructions (e.g., software, firmware), electronic data, databases, or other digital information. The storage medium 606 may also be used for storing data that is manipulated by the processing circuit 602 when executing programming. The storage medium 606 may be any available media that can be accessed by a general purpose or special purpose processor, including portable or fixed storage devices, optical storage devices, and various other mediums capable of storing, containing and/or carrying programming. By way of example and not limitation, the storage medium 606 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 606 may be coupled to the processing circuit 602 such that the processing circuit 602 can read information from, and write information to, the storage medium 606. That is, the storage medium 606 can be coupled to the processing circuit 602 so that the storage medium 606 is at least accessible by the processing circuit 602, including examples where the storage medium 606 is integral to the processing circuit 602 and/or examples where the storage medium 606 is separate from the processing circuit 602 (e.g., resident in the access terminal 600, external to the access terminal 600, distributed across multiple entities).

Programming stored by the storage medium 606, when executed by the processing circuit 602, causes the processing circuit 602 to perform one or more of the various functions and/or process steps described herein. For example, the storage medium 606 may include: codec selection operations 618, signal encoding operations 626, call initiation operations 628, and/or subscription selection operations 630. The codec selection operations 618 are adapted to cause the processing circuit 602 (e.g., the codec selector circuit/module 612) to select a codec format in a manner to reduce the use of transcoders along a communication path between another access terminal, as described herein. The subscription selection operations 630 are adapted to cause the processing circuit 602 (e.g., the subscription selector circuit/module 624) to switch between available subscriptions to attempt to establish a transcoder-free communication path. For instance, if a transcoder-free communication path cannot be established using a first subscription, a second subscription is used to attempt to establish the transcoder-free communication path. The call initiation operations 628 are adapted to cause the processing circuit 602 (e.g., the call initiation circuit/module 622) to initiate a call with a terminating communication device using the first subscription and/or the second subscription. The signal encoding operations 626 are adapted to cause the processing circuit 602 (e.g., the signal encoder circuit/module 620) to encode a wideband audio signal using a narrowband codec for transmission via the communications interface 604 using the transcoder-free communication path.

Thus, according to one or more aspects of the present disclosure, the processing circuit 602 is adapted to perform (in conjunction with the storage medium 606) any or all of the processes, functions, steps and/or routines for any or all of the access terminals (e.g., access terminal 104, 302, 304, 402, 416, 502, 516, 600) described herein. As used herein, the term “adapted” in relation to the processing circuit 602 may refer to the processing circuit 602 being one or more of configured, employed, implemented, and/or programmed (in conjunction with the storage medium 606) to perform a particular process, function, step and/or routine according to various features described herein.

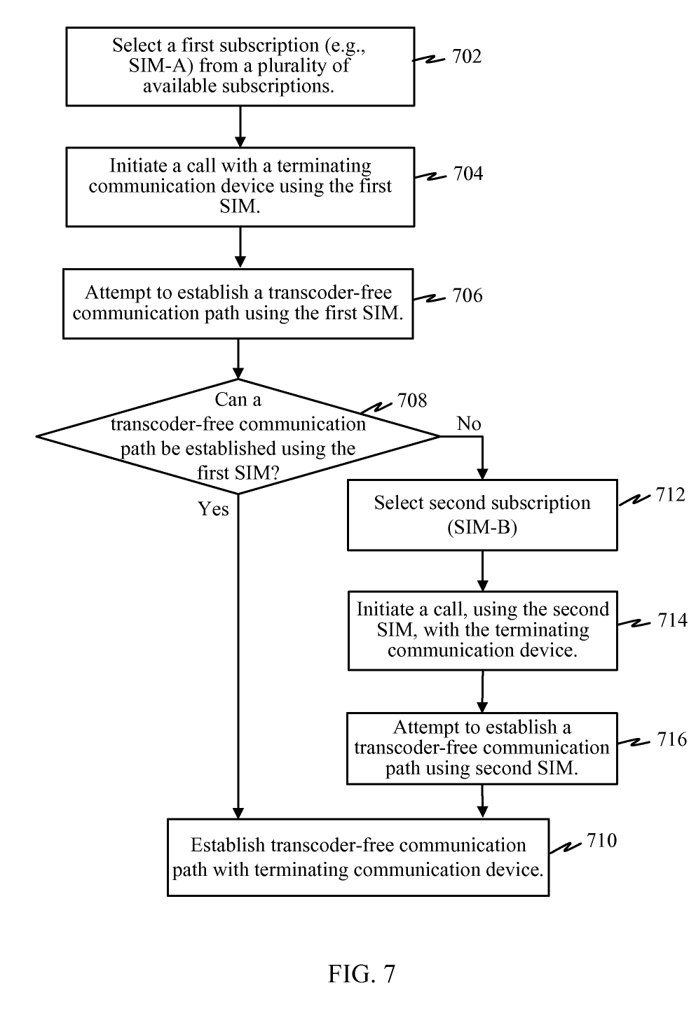

FIG. 7 is a flow diagram illustrating at least one example of a method operational on an access terminal, such as the access terminal 600. Referring to FIGS. 6 and 7, an access terminal 600 can select a first subscription from among a plurality of available subscription at 702. For example, the processing circuit 602 may enable operation of the first subscription module, SIM-A 608.

At 704, the access terminal 600 can initiate a call with a terminating communication device using the first subscription. For example, the processing circuit 602 may initiate a call with a terminating communication device using the first subscription module, SIM-A 608, as set forth in FIG. 5.

As part of the call initiation, the access terminal 600 can attempt to establish a transcoder-free communication path using the first subscription, at 706. For example, the processing circuit 602 (e.g., the call initiation circuit/module 622 and/or the codec selector circuit/module 612) executing the call initiation operations and/or codec selection operations 618 may attempt establishment of a transcoder-free communication path using the first subscription module, SIM-A 608, as part of initiating the call with the terminating communication device.

At 708, the access terminal 600 may determine whether a transcoder-free communication path was able to be established using the first subscription. For instance, the processing circuit 602 (e.g., the call initiation circuit/module 622) executing the call initiation operations 628 may determine whether a codec has been selected using the first subscription module, SIM-A 608, for transcoder-free communication with the terminating communication device. In at least some examples, the processing circuit 602 may receive via the communications interface 604 a message adapted to indicate a codec that has been selected or that no codec has been selected. A message indicating that no codec has been selected can inform the access terminal 600 that a transcoder-free communication path cannot be established using the first subscription.

If the access terminal 600 determines at 708 that a transcoder-free communication path can be established using the first subscription, then the access terminal 600 can establish the transcoder-free communication path with the terminating communication device at 710. For example, the processing circuit 602 (e.g., the codec selector circuit/module 612) executing the codec selection operations 618 may establish a radio bearer.

In some implementations, network operators may use narrowband voice codecs for voice calls since upgrading their infrastructure for wideband codecs is expensive. In some instances, the access terminal 600 may use watermarking techniques to transmit wideband speech content over standardized narrowband codec bit-streams. Since the wideband information is watermarked, the terminating communication device will not be able to decode the wideband information in the presence of transcoders in the communication path. A transcoder-free communication path enables the access terminal 600 to take advantage of watermarking techniques for delivering wideband speech quality over standardized narrowband codecs, thereby improving the user experience. Thus, with a transcoder-free communication path established at 710, the processing circuit 602 can encode a wideband audio signal using a narrowband codec for transmission via the communications interface 604.

If, on the other hand, the access terminal 600 determines at 708 that a transcoder-free communication path cannot be established using the first subscription, then the access terminal selects the second subscription at 712. For instance, the processing circuit 602 (e.g., the subscription selector circuit/module 624) executing the subscription selection operations 630 may switch to the second subscription module, SIM-B 610, in response to the indication that a transcoder-free communication path cannot be established using the first subscription module, SIM-A 608.

With the access terminal 600 operating on the second subscription, a call may again be initiated with the terminating communication device using the second subscription, at 714. For example, the processing circuit 602 (e.g., the call initiation circuit/module 622 and/or the codec selector circuit/module 612) executing the codec selection operations 618 may initiate a call with the terminating communication device using the second subscription module, SIM-B 610.

As part of the call initiation using the second subscription, the access terminal 600 can attempt to establish a transcoder-free communication path, at 716. For example, the processing circuit 602 (e.g., the call initiation circuit/module 622 and/or the codec selector circuit/module 612) executing the call initiation operations 628 and/or codec selection operations 618 may attempt establishment of a transcoder-free communication path using the second subscription module, SIM-B 610, as part of initiating the call with the terminating communication device.

Following the attempt to establish a transcoder-free communication path using the second subscription, the access terminal 600 can establish a communication path with the terminating communication device, at 710. For example, the processing circuit 602 (e.g., the subscription selector circuit/module 624, call initiation circuit/module 622, and/or the codec selector circuit/module 612) executing the subscription selection operations 630, call initiation operations 628, and/or codec selection operations 618 may establish a radio bearer.

If a transcoder-free communication path is available, then the processing circuit 602 can establish the communication path as a transcoder-free communication path with the terminating communication device using the second subscription module, SIM-B 610, at 710. With a transcoder-free communication path established, the processing circuit 602 can encode a wideband audio signal using a narrowband codec for transmission via the communications interface 604.

It may still occur, however, that a transcoder-free communication path cannot be established for either the first subscription or the second subscription. In such instances, the processing circuit 602 (e.g., the subscription selector circuit/module 624, call initiation circuit/module 622, and/or codec selector circuit/module 612) executing the subscription selection operations 630, call initiation operations 628, and/or codec selection operations 618 may simply establish a communication path with the terminating communication device including at least one transcoder using either the first subscription or the second subscription. In one example, a path with the least number of transcoders is established over the first or second subscriptions. Alternatively, the access terminal 600 may switch to or use a preferred, default, and/or initial subscription to establish a communication path. In yet another alternative implementation, the access terminal 600 may use the most recent or last attempted subscription to establish a communication path (e.g., thereby avoiding the time to switch back to yet another subscription).

While the above discussed aspects, arrangements, and embodiments are discussed with specific details and particularity, one or more of the components, steps, features and/or functions illustrated in FIGS. 1, 2, 3, 4, 5, 6 and/or 7 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, 3, 4, 5, and/or 6 may be configured to perform or employ one or more of the methods, features, parameters, and/or steps described in FIGS. 4, 5, and/or 7. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a non-transitory machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. An access terminal, comprising:
a communications interface;
a plurality of subscription modules, including a first subscription module associated with a first subscription, and a second subscription module associated with a second subscription; and
a processing circuit coupled to the communications interface and the plurality of subscription modules, the processing circuit adapted to:
initiate a call with a terminating communication device via the communications interface using the first subscription module;
switch to the second subscription module if a transcoder-free communication path cannot be established using the first subscription module; and
initiate the call with the terminating communication device via the communications interface using the second subscription module.

2. The access terminal of claim 1, wherein the processing circuit is further adapted to:
attempt establishment of a transcoder-free communication path using the first subscription module as part of initiating the call with the terminating communication device using the first subscription module.

3. The access terminal of claim 1, wherein the processing circuit is further adapted to:
attempt establishment of a transcoder-free communication path using the second subscription module after switching to the second subscription module as part of initiating the call with the terminating communication device using the second subscription module.

4. The access terminal of claim 1, wherein the processing circuit is further adapted to:
receive, via the communications interface, an indication that a transcoder-free communication path cannot be established using the first subscription module.

5. The access terminal of claim 1, wherein the processing circuit is further adapted to:
establish a transcoder-free communication path with the terminating communication device using the second subscription module.

6. The access terminal of claim 5, wherein the processing circuit is further adapted to:
encode a wideband audio signal using a narrowband codec for transmission via the communications interface using the transcoder-free communication path.

7. The access terminal of claim 1, wherein the processing circuit is further adapted to:
establish a transcoded communication path with the terminating communication device when a transcoder-free communication path cannot be established using either the first subscription module or the second subscription module.

8. A method operational on a multi-subscription access terminal, comprising:
initiating a call with a terminating communication device using a first subscription;
switching to a second subscription if a transcoder-free communication path cannot be established with the terminating communication device using the first subscription module; and
initiating the call with the terminating communication device using the second subscription.

9. The method of claim 8, wherein initiating the call with the terminating communication device using the first subscription comprises:
attempting to establish a transcoder-free communication path using the first subscription.

10. The method of claim 8, wherein initiating the call with the terminating communication device using the second subscription comprises:
attempting to establish a transcoder-free communication path using the second subscription.

11. The method of claim 8, further comprising:
prior to switching to the second subscription, receiving an indication that a transcoder-free communication path cannot be established using the first subscription.

12. The method of claim 8, further comprising:
establishing a transcoder-free communication path with the terminating communication device using the second subscription.

13. The method of claim 12, further comprising:
encoding a wideband audio signal using a narrowband codec for transmission using the transcoder-free communication path.

14. The method of claim 8, further comprising:
establishing a communication path with the terminating communication device including at least one transcoder when a transcoder-free communication path cannot be established using either the first subscription or the second subscription.

15. An access terminal, comprising:
means for initiating a call with a terminating communication device using a first subscription;
means for switching to a second subscription if a transcoder-free communication path cannot be established with the terminating communication device using the first subscription module; and
means for initiating the call with the terminating communication device using the second subscription.

16. The access terminal of claim 15, further comprising:
means for attempting to establish a transcoder-free communication path using the first subscription.

17. The access terminal of claim 15, further comprising:
means for attempting to establish a transcoder-free communication path using the second subscription after switching to the second subscription.

18. The access terminal of claim 15, further comprising:
means for receiving an indication that a transcoder-free communication path cannot be established using the first subscription module.

19. The access terminal of claim 15, further comprising:
means for establishing a transcoder-free communication path with the terminating communication device using the second subscription module.

20. The access terminal of claim 19, further comprising:
means for encoding a wideband audio signal using a narrowband codec for transmission via the communications interface using the transcoder-free communication path.

21. The access terminal of claim 15, further comprising:
means for establishing a communication path with the terminating communication device including at least one transcoder when a transcoder-free communication path cannot be established using either the first subscription or the second subscription.

22. A non-transitory processor-readable storage medium having one or more instructions which, when executed by at least one processing circuit, cause the at least one processing circuit to:
initiate a call with a terminating communication device using a first subscription;
switch to a second subscription if a transcoder-free communication path cannot be established with the terminating communication device using the first subscription module; and
initiate the call with the terminating communication device using the second subscription.

23. The non-transitory processor-readable storage medium of claim 22 further having one or more instructions which, when executed by at least one processing circuit, cause the at least one processing circuit to:
attempt to establish a transcoder-free communication path using the first subscription module as part of initiating the call with the terminating communication device using the first subscription module.

24. The non-transitory processor-readable storage medium of claim 22 further having one or more instructions which, when executed by at least one processing circuit, cause the at least one processing circuit to:
attempt to establish a transcoder-free communication path using the second subscription module after switching to the second subscription module as part of initiating the call with the terminating communication device using the second subscription module.

25. The non-transitory processor-readable storage medium of claim 22 further having one or more instructions which, when executed by at least one processing circuit, cause the at least one processing circuit to:
receive an indication that a transcoder-free communication path cannot be established using the first subscription module.

26. The non-transitory processor-readable storage medium of claim 22 further having one or more instructions which, when executed by at least one processing circuit, cause the at least one processing circuit to:
establish a transcoder-free communication path with the terminating communication device using the second subscription module.

27. The non-transitory processor-readable storage medium of claim 26 further having one or more instructions which, when executed by at least one processing circuit, cause the at least one processing circuit to:
encode a wideband audio signal using a narrowband codec for transmission using the transcoder-free communication path.

28. The non-transitory processor-readable storage medium of claim 22 further having one or more instructions which, when executed by at least one processing circuit, cause the at least one processing circuit to:
establish a communication path with the terminating communication device including at least one transcoder when a transcoder-free communication path cannot be established using either the first subscription or the second subscription.
